(19) United States
(12) Patent Application Publication
(10) Pub. No.: US 2008/0267557 A1
(43) Pub. Date: Oct. 30, 2008

(54) Integrated Magneto-Optical Devices for Uni-Directional Optical Resonator Systems

(76) Inventors: Zheng Wang, Cambridge, MA (US); Shanhui Fan, Stanford, CA (US)

Correspondence Address: DAVIS WRIGHT TREMAINE LLP, 505 MONTGOMERY STREET, SUITE 800, SAN FRANCISCO, CA, 94111, US

(21) Appl. No.: 11/616,438

(22) Filed: Dec. 27, 2006

Related U.S. Application Data
(60) Provisional application No. 60/755,274, filed on Dec. 29, 2005.

(51) Int. Cl. G02B 6/26; G02F 1/09

(52) U.S. Cl. 385/16; 359/281

(57) ABSTRACT

A resonator system comprises an optical resonator that supports one or more pairs of nearly degenerate defect states. One or more magnetic domains comprising at least one gyrotropic material in the optical resonator cause magneto-optical coupling between the two states so that the system lacks time-reversal symmetry. In one embodiment, a single magnetic domain is used that dominates induced magneto-optical coupling between the defect states. The above resonator system may be used together with other components such as waveguides to form circulators, add drop filters, switches and memories.

### CROSS-REFERENCE TO RELATED APPLICATIONS

This non-provisional application claims the benefit of provisional application No. 60/755,274, filed Dec. 29, 2005, which application is incorporated herein in its entirety by this reference.

### BACKGROUND OF THE INVENTION

This invention relates to magneto-optical devices and in particular to magneto-optical uni-directional resonator systems and their applications.

Nonreciprocal optical devices are important components in large-scale optical system and networks. These devices regulate the signal propagation along a single direction, thereby preventing reflection between stages and allowing the separation of the forward and backward signal flow.

Two-way propagation of optical signal can destabilize the operation of an optical system and contribute to elevated noise level. From the reciprocity principle, regular dielectric optical systems allow signal propagation along both forward and the backward directions. Most optical devices, particularly in integrated circuits, reflect incident light to a certain extent, and thereby introduce coupling between cascaded stages. Optical resonances, commonly used in lasers, modulators and filters, would experience a resonance frequency pulling, depending on the amplitude and the phase of the inter-stage coupling. The resultant system response functions can vary substantially from the designed characteristics. To allow a practical tolerance for fabrication and assembly error, nonreciprocal devices are used to block the reflected beam, such as optical isolators used in most laser systems.

A common approach to obtain non-reciprocity at optical wavelength is based on a linear magneto-optical effect, known as gyrotropy. It has been used in most commercially-available bulk optical isolator or circulator structures, where large isolation and minimal insertion loss can be simultaneously achieved. The dimension of such devices, however, tends to be very large at a length scale on the order of millimeters. The strength of gyrotropy in existing magneto-optical material, measured by the Voigt parameter, is at most 10⁻² and typically less than 10⁻³. Consequently the signal interaction length needs to be at least hundreds of wavelengths.

One device configuration to generate large nonreciprocal effect is known as the Voigt configuration, where the external bias (magnetic field) is applied perpendicular to the optical path. The magneto-optical effect manifests as a small difference in the propagation constant of the forward and backward waves. This difference can be converted into a large difference in forward and backward transmission coefficient, using various forms of interferometers, such as a Mach-Zehnder interferometer. The need for a long interaction length still applies to devices based on such nonreciprocal phase shift, including many integrated magneto-optical waveguide isolators. R. Wolfe, R. A. Lieberman, V. J. Fratello, R. E. Scotti, and N. Kopylov, “Etch-tuned ridged waveguide magneto-optic isolator,” Applied Physics Letters, vol. 56, pp. 426-428, 1990; M. Levy, I. Ilic, R. Scarmozzino, R. M. Osgood, Jr., R. Wolfe, C. J. Gutierrez, and G. A. Prinz, “Thin-film-magnet magnetooptic waveguide isolator,” IEEE Photonics Technology Letters, vol. 5, pp. 198-200, 1993; M. Levy, “The on-chip integration of magnetooptic waveguide isolators,” IEEE Journal of Selected Topics in Quantum Electronics, vol. 8, pp. 1300-6, 2002. In these devices, while the lateral dimensions have been reduced to several microns, the length remains comparable to bulk devices.

The Faraday configuration is another type of device design commonly used in bulk nonreciprocal devices. Here the external bias is aligned parallel to the propagation direction of the light beam. To reduce the length of the devices, magneto-optical resonators have been developed to trade the operational bandwidth for shorter optical path. Experimentally demonstrated, enhanced Faraday rotation in one-dimensional photonic crystal defect systems can significantly shorten the total device length necessary for a 45° polarization rotation by one order of magnitude. M. Inoue, K. Arai, T. Fujii, and M. Abe, “Magneto-optical properties of one-dimensional photonic crystals composed of magnetic and dielectric layers,” Journal of Applied Physics, vol. 83, pp. 6768-6770, 1998; M. J. Steel, M. Levy, and R. M. Osgood, “High transmission enhanced Faraday rotation in one-dimensional photonic crystals with defects,” IEEE Photonics Technology Letters, vol. 12, pp. 1171-3, 2000. The application of such scheme in today's on-chip optical circuits, however, is fundamentally limited by the problem of weak light confinement in the transversal dimension, which results in large lateral component sizes, and the inconvenient co-linear magnetic biasing.

It is therefore desirable to provide magneto-optical uni-directional resonator systems which overcome the above shortcomings.

### SUMMARY

A resonator system comprises an optical resonator that supports one or more pairs of nearly degenerate defect states. One or more magnetic domains comprising at least one gyrotropic material in the optical resonator cause magneto-optical coupling between the two states so that the system lacks time-reversal symmetry. In one embodiment, a single magnetic domain is used that dominates induced magneto-optical coupling between the defect states.

The above resonator system may be used together with other components such as waveguides to form circulators, add drop filters, switches and memories.

### BRIEF DESCRIPTION OF THE DRAWINGS

FIG. 1a is diagram of a defect structure in a photonic crystal. The crystal consists of a triangular lattice of air holes with a radius of 0.35a, introduced in a dielectric of ε=6.25. The defect is created by reducing the radius of a single air hole.

FIG. 1b is a graphical plot of the frequency of the defect modes as a function of the radius of the center air hole in the defect region for the two-dimensional bismuth-iron-garnet photonic crystal. The calculation is performed using a plane-wave expansion method.

FIGS. 2a and 2b are images representing the Hz field distribution of the two doubly-degenerate dipole modes in the BIG photonic crystal cavity as shown in FIGS. 1a and 1b. The shading represents intensities so that the darker regions represent regions of magnetic fields of higher intensities than lighter regions. The positive and negative Hz intensity values are labeled “+” and “−” accordingly. The vector plots (illustrated by arrows) represent the E fields.

FIG. 3a is a diagram illustrating the cross-product between the E-fields of the two modes shown in FIGS. 2a and 2b.

FIG. 3b is a diagram illustrating the corresponding domain pattern that maximizes the magneto-optical coupling constant of the two modes shown in FIGS. 2a and 2b.

FIG. 3c is a diagram illustrating the spatial distribution of the modal cross-product of the dipole modes in an infiltrated BIG cavity in a silicon crystal. The Black dashed circle represents the position of the BIG rod.

FIG. 3d is a diagram illustrating the corresponding optimized domain pattern using only single domain. In FIGS. 3a-3d, the positive and negative Hz intensity values are labeled “+” and “−.”

FIG. 4a is a graphical plot of the magneto-coupling strength in an infiltrated silicon photonic crystal cavity as a function of the radius of the BIG rod.

FIG. 4b is a graphical plot of the magneto-optical splitting between the dipole modes as a function of εₐ for the cavity in BIG crystal and the infiltrated silicon cavity with rBIG=0.4a.

FIG. 5a is a graphical plot of the frequency of the defect modes as a function of the radius of the center BIG rod in the defect region for the two-dimensional silicon photonic crystal.

FIG. 5b is a diagram illustrating an octapole mode in the infiltrated silicon cavity with r_{BIG}=0.4a.

FIG. 5c is a diagram illustrating the modal cross product of the octapole mode of FIG. 5b with the even mode in FIG. 2a.

FIG. 5d is a diagram illustrating the modal cross product of the octapole mode of FIG. 5b with the odd mode in FIG. 2b. The dashed circles in FIGS. 5c and 5d represent the position of the BIG rods. The radius of the six holes next to the center defect is reduced to 0.3a to push the dipole modes to the center of the gap. In FIGS. 5b-3d, the positive and negative Hz intensity values are labeled “+” and “−.”

FIG. 6a is a schematic view of a three-port Y-junction circulator. The straight arrows indicate the incoming and outgoing waves. The curved arrows represent the two counter-rotating modes in the resonator.

FIG. 6b is a schematic view of a three-port Y-junction circulator constructed as a point defect coupled to three waveguides. Circles correspond to air holes in Bismuth Iron Garnet. The light and dark gray areas represent the magnetic domains with opposite out-of-plane magnetization direction.

FIG. 6c is a graphical plot of the transmission spectra at the output and isolated ports of a three-port junction circulator of FIG. 6b. The finite-difference time-domain spectra (dots) agree well with the coupled-mode theory analysis (solid curves).

FIGS. 7a-7d are diagrams illustrating the out-of-plane H field patterns of the three-port junction circulator shown in FIG. 6c when excited at ω=0.3468 (c/a). The positive and negative Hz intensity values are labeled “+” and “−.” Non-magneto-optical cavity (εₐ=0) excited at the input port; b a magneto-optical cavity with εₐ=0.02463, excited at the input port; the identical magneto-optical cavity is also seen as excited at the output port in c and at the isolated port in d.

FIG. 8a is a schematic view of a four-port channel add-drop filter (ADF). The straight arrows indicate the incoming and outgoing waves. The curved arrows represent the two counter-rotating modes in the resonator.

FIG. 8b is a graphical plot of the spectra of transfer efficiency of various four-port ADFs. The taller curve at the center represents an ideal ADF resonant at ω₀ with a line-width γ. Such an ADF supports two resonant modes that are degenerate in both frequency and linewidth. The shorter dashed line curve at the center corresponds to a filter structure in which the two modes have the same width γ, and with a frequency split of 1.7γ. The two curves on the two sides of the center curve correspond to the transfer efficiency from ports 1 to 2 (2 to 1), in the presence of a strong magneto-optical coupling with a coupling strength κ.

FIGS. 9a and 9b are diagrams illustrating a pair of degenerate even and odd resonant modes respectively of a 2D ring resonator consisting of a ring of high-index material. The structure can be seen as the intensity of the magnetic field along out-of-plane direction is represented as the “+” and “−” regions.

FIG. 9c is a diagram of the corresponding magnetic domain structure necessary to couple the modes plotted in FIGS. 9a and 9b.

FIG. 10a is a top view of a micro-ring add/drop filter 150, where the high-index materials are outlined with black lines, in which a ring shaped structure 152 is identical to the structure in FIG. 9c. Filter 150 also includes a top waveguide 156 and a bottom waveguide 158. The fields snapshot (with darker shading labeled D representing high field intensity regions) in FIG. 10a is calculated with finite-different time domain method and represents the magnetic field of the structure excited from the top left port of the waveguide.

FIG. 10b is a graphical plot of the field transmission spectra of the device excited with the left port of the top waveguide.

FIG. 10c is a graphical plot of the field transmission spectra of the device excited with the left port of the bottom waveguide.

FIG. 11 is a schematic view of 2D photonic crystal slabs implementation of a 3-port circulator structure formed by a silicon slab with lithographically defined airholes. One of the holes is infiltrated with Ce:YIG and the waveguides are enlarged airholes,

FIG. 12 is a schematic view of electrically tunable circulator (a reconfigurable optical switch) from the side view, formed by a photonic crystal slab on top of a permanent magnet and an inductor. The arrows represent the direction of the magnetization or the magnetic fields. Note the permanent magnet also consists of several magnetic domains (naturally occurring in garnet films to lower the magneto-static energy). The integrated circuit inductor can be fabricated with standard CMOS process and wafer-bond to the optical chip.

For convenience in description, identical components are labeled by the same numbers in this application.

### DETAILED DESCRIPTION

This disclosure covers optical devices employing planar optical resonances evanescently coupled to optical waveguides. Gyrotropic materials are introduced into the resonator to provide non-reciprocal effects to achieve optical isolation. Additionally, these non-reciprocal resonances are robust against many effects caused by disorders.

In this context, we specific demonstrate the concept of nonreciprocal resonances in two-dimensional photonic crystals by domain engineering. Photonic crystal slabs are promising candidates for large-scale optical integration that are necessary to address the increasing demand of optical information processing for broader communication bandwidth. S. John, “Strong localization of photons in certain disordered dielectric superlattices,” Physical Review Letters, vol. 58, pp. 2486-9, 1987; E. Yablonovitch, “Inhibited spontaneous emission in solid-state physics and electronics,” Physical Review Letters, vol. 58, pp. 2059-62, 1987; J. D. Joannopoulos, R. D. Meade, and J. N. Winn, “Photonic crystals: molding the flow of light,” Princeton, N.J.: Princeton University Press, 1995. Its advantages include the strong in-plane field confinement from the photonic band gap and the compatibility with planar on-chip circuits.

Firstly, we demonstrate that nonreciprocal transport among waveguides can be accomplished in a low-loss and large-bandwidth three-port junction circulator. The transmission between adjacent ports is uni-directional and can provide a 30 dB-isolation bandwidth well over 100 GHz. The highly reduced device dimension, on the order of a single wavelength, allows tight integration in functional systems. When absorbing materials are present at the isolated port, the circulator can serve as an optical isolator. In addition, channel add/drop can be performed with the wavelength-selective reflectors.

Similarly, a four-port circulator can be designed using a magnetized four-port optical add/drop filter. The magneto-optical coupling between the two degenerate resonances in the structure breaks the time reversal symmetry. The resonance tunneling therefore transmits light only along a single direction in certain wavelength range and such a resonator functions as an ultra-compact optical circulator.

More importantly, in the limit of a strong magneto-optical coupling, ideal channel add/drop characteristics can occur independent of small structural variations. The strong magneto-optical coupling dominates disorder-induced mode coupling and stabilize the ideal transmission lineshape in the presence of fabrication related roughness.

The suitable resonator structures that exhibit large nonreciprocal effects are not limited to photonic crystal systems. Micro-ring(disk) resonators, for example, can benefit from the same magneto-optical effects, as nonreciprocal devices and disorder-tolerant filters.

In addition, since the transport properties of these devices are strongly influenced by domain structures. We can exploit the nonvolatile magnetization (as permanent magnets) in some iron garnet films. These garnet films can be used directly in the photonic crystal cavity as the gyrotropic core or can be used to generate the bias field. By rewriting the magnetization direction of the magnetic domain, one can readily reprogram the switching property of the circulators and control the routing configuration in optical circuits. The required DC magnetic field can be created by an inductor, which has been routinely miniaturized to micron scale in integrated circuit and can be wafer bond to the optical chip. The direction of the inductor current dictates the polarity of the applied magnetic field, which in turn controls the magnetization of the permanent magnet and the magnetic core of the photonic crystal cavity, as shown in FIG. 16.

### Magneto-Optical Coupling of Defect States

Before we discuss specific magneto-optical resonances, let's briefly review some of the basic properties of magneto-optical materials. At optical wavelengths, the gyrotropy of a magneto-optical material is characterized by a dielectric tensor:

$$\overleftrightarrow{ɛ} = ( \begin{matrix}{ɛ}_{⊥} & {iɛ}_{a} & 0 \\ - {iɛ}_{a} & {ɛ}_{⊥} & 0 \\ 0 & 0 & {ɛ}_{\vert \vert}\end{matrix} ) , \qquad ( 1 )$$

when the magnetization is along the z direction. Here, for simplicity, we ignore the absorption and assume ε_{⊥}, ε_{∥}and ε_{α} to be real. The ε_{α} in the off-diagonal elements has its sign dictated by the direction of magnetization. The strength of magneto-optical effects is measured by the Voigt parameter Q_{M}=ε_{α}/ε_{⊥}.

Here we take photonic crystal cavities as an example, to solve the optical eigne-modes in the presence of magnetio-optical materials. To theoretically describe the modes in a magneto-optical defect structures in a photonic crystal, we use a Hamiltonian formalism, Y. Xu, Y. Li, R. K. Lee, and A. Yariv, “Scattering-theory analysis of waveguide-resonator coupling,” Physical Review E (Statistical Physics, Plasmas, Fluids, and Related Interdisciplinary Topics), vol. 62, pp. 7389-404, 2000, where the resonator mode

$$\vert ψ 〉 = [ \begin{matrix}\vec{E} \\ \vec{H}\end{matrix} ]$$

at a frequency ω is the solution of the eigenvalue equation

$$\begin{matrix}Θ \vert ψ 〉 = ω \vert ψ 〉 , \\ with & ( 2 ) \\ Θ = [ \begin{matrix}0 & i {\overleftrightarrow{ɛ}}^{- 1} \vec{∇} \times \\ - i {μ}_{0}^{- 1} \vec{∇} \times & 0\end{matrix} ] & ( 3 )\end{matrix}$$

as defined by the Maxwell's equations.

This eigenvalue equation can be solved numerically. Here, however, to exhibit the general features of modal structures in a magneto-optical resonator, we exploit the fact that the Voigt parameter is typical less than 10⁻³ and use a perturbative approach where the Hamiltonian is split into a non-magneto part Θ₀ and a gyrotropic perturbation V as Θ=Θ₀+V, where

$${Θ}_{0} = [ \begin{matrix}0 & {iɛ}_{⊥}^{- 1} \vec{∇} \times \\ - {iμ}_{0}^{- 1} \vec{∇} \times & 0\end{matrix} ] \\ V = [ \begin{matrix}0 & i ( {\overleftrightarrow{ɛ}}^{- 1} - I {ɛ}_{⊥}^{- 1} ) \vec{∇} \times \\ 0 & 0\end{matrix} ] . \qquad ( 4 )$$

The effects of gyrotropy are entirely encapsulated by V, which induces magneto-optical coupling between the eigenmodes of the non-magnetic photonic crystal described by Θ₀.

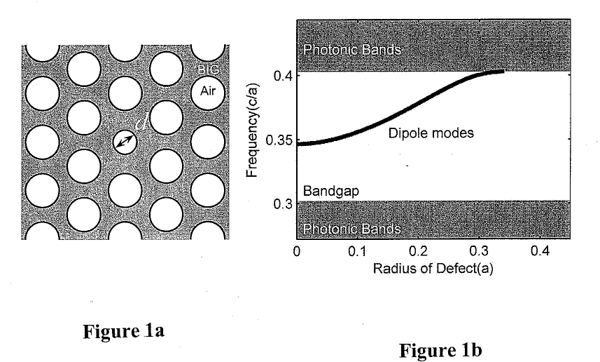

For concreteness, we consider the simple case of a system supporting two nearly-degenerate defect states, where the effect of magneto-optical coupling is particularly prominent. The structure shown in FIG. 1a consists of a two-dimensional photonic crystal with a triangular lattice of air holes in Bismuth Iron Garnet (BIG) with ε_{⊥}=6.25. (FIG. 1a) The air holes have a radius of 0.35a, where a is the lattice constant. The corresponding nonmagnetic photonic crystal (described by Θ₀) exhibits a large TE bandgap in the frequency range of 0.302 to 0.403 c/a. Reducing the radius r of a single air hole creates a pair of degenerate dipole defect modes into the bandgap (FIG. 1b). A cavity with r=0 supports modes at a mid-gap frequency of 0.346 c/a.

These two modes can be categorized as an even mode

[symbol]

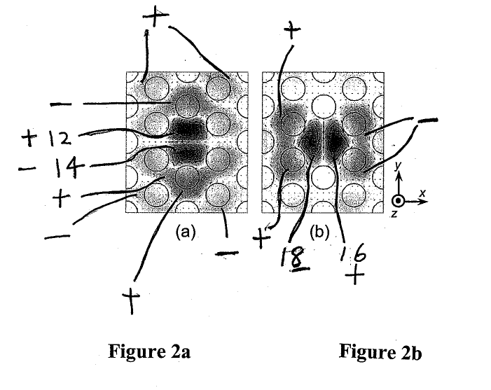

(FIG. 2a) and an odd mode [symbol]
(FIG. 2b) with respect to the y-direction mirror symmetry plane of the crystal. Equivalently, the two eigenmodes can be also chosen as a pair of rotating states (|e [symbol] ±i|o [symbol] )/\sqrt{2}. S. Fan, P. R. Villeneuve, J. D. Joannopoulos, and H. A. Haus, “Channel drop tunneling through localized states,” Physical Review Letters, vol. 80, pp. 960-963, 1998. Since ^{Θ}₀ by itself possesses time-reversal symmetry, these two rotating modes, which transform into each other with a time-reversal operation, necessarily have the same frequency.

As shown in FIGS. 2a and 2b, the arrows illustrate the directions of the electric or E fields, and the labels “+” and “−” illustrate the regions with opposite directions of the magnetic or H fields. Regions labeled “+” are those where the H field is pointing into the plane of the paper and regions labeled “−” are those where the H field is pointing out of the plane of the paper. The right hand rule of electromagnetism applies here so that where the E fields are in a clockwise direction, as in regions 12 and 16, the H field is pointing out of the plane of the paper, so that these regions are labeled “−.” Where the E fields are in a counter clockwise direction, as in regions 14 and 18, the H field is pointing into the plane of the paper, so that these regions are labeled “+.” It will be noted that the E fields are ideally located in the plane of the paper and the H fields are ideally normal to the plane of the paper. The intensity of the H fields is illustrated by the degree of shading in FIGS. 2a and 2b. Thus, regions 12, 14, 16 and 18 are the regions with the highest H field intensities. The above convention for illustrating the directions, relationship and intensities of the E and H fields for FIGS. 2a and 2b is used in other figures of this application.

However, in practical devices, the E fields may not be entirely in the same plane, but may deviate from such ideal, to the extent that the E fields no less than 20% of its peak value is aligned within 10 degrees from the plane (referred to below as “E fields being substantially confined to the plane”), where the plane may be defined in reference to certain physical characteristics of the devices. In practical devices, the H fields may not be entirely be normal to the same plane, but may deviate from such ideal, to the extent that the H fields no less than 20% of its peak value is aligned within by up to 10 degrees from the perpendicular direction to the plane. Where the H field deviates from the perpendicular direction to the plane by up to 10 degrees, the H field is said to be in a near normal direction.

The effect of gyrotrophy, described by the operator V, is to introduce magneto-optical coupling between the eigenmodes of Θ₀. With the basis of the eigenmodes of Θ₀, the Hamiltonian Θ can be rewritten as Y. Xu, Y. Li, R. K. Lee, and A. Yariv, “Scattering-theory analysis of waveguide-resonator coupling,” Physical Review E (Statistical Physics, Plasmas, Fluids, and Related Interdisciplinary Topics), vol. 62, pp. 7389-404, 2000.

$${Θ}_{0} = {\sum }_{α} {ω}_{α} \vert {ψ}_{α} 〉 〈 {ψ}_{α} \vert , V = {\sum }_{α , β} {V}_{αβ} \vert {ψ}_{α} 〉 〈 {ψ}_{β} \vert . \qquad ( 5 )$$

To the first order of ε_{α}, the coupling strength between any two modes α and β can be derived as:

$${V}_{αβ} = \frac{i}{2} \frac{\sqrt{{ω}_{α} {ω}_{β}} \int {ɛ}_{a} \hat{z} \cdot ( {\vec{E}}_{α}^{*} \times {\vec{E}}_{β} ) d V}{\sqrt{\int {ɛ}_{⊥} {\vert {\vec{E}}_{α} \vert}^{2} d V \int {ɛ}_{⊥} {\vert {\vec{E}}_{β} \vert}^{2} d V}} , \qquad ( 6 )$$

where the sign of ε_{α} is determined by the direction of the magnetization vector, and Ē_{α} is the electrical field for the unperturbed mode |Ψ_{α} [symbol]
Thus the magneto-optical coupling is closely related to the spatial arrangement of the magnetic domain as well as the vectorial field distribution of the defect states.

When we choose the standing-wave modes with real-valued electromagnetic fields as the eigenmode basis, the coupling constant (Vₑₒ) between them is purely imaginary. Therefore, for the structure as shown in FIGS. 2a and 2b, in the subspace of |e

[symbol]

and |o [symbol]
when ωₑ=ωₒ, the Hamiltonian of the system is

$$Θ = ( \begin{matrix}{ω}_{e} & {V}_{eo} \\ - {V}_{eo} & {ω}_{e}\end{matrix} ) \qquad ( 7 )$$

when magneto-optical materials are present in the cavity. The eigenstates for the Hamiltonian in Eq. (7) take the rotating wave form |e [symbol]
±i|o [symbol]
with a frequency splitting of 2|Vₑₒ|. We denote this pair of eigenstates in the magneto-optical cavity as |+ [symbol]
and |− [symbol]
with their resonance frequencies being ωₑ+|Vₑₒ| and ωₑ−|Vₑₒ| respectively. Since the two counter rotating modes are related by a time-reversal operation, the frequency splitting between them clearly indicates the breaking of time-reversal symmetry and reciprocity. Also, importantly, even in the case where ωₑ deviates from ωₒ, for example due to fabrication related disorders that break the three-fold rotational symmetry, as long as the magneto-optical coupling is sufficiently strong, i.e. |Vₑₒ|>>|ωₑ-ωₒ|, |e [symbol]
±i|o [symbol]
remain the eigenstates of the system. Thus, in the limit of strong magneto-optical coupling, such modes assume a general waveform of circular hybridization independent of small structural disorders that would almost always occur in practical devices. For example, in application of optical isolators, |Vₑₒ|>3×|ωₑ-ωₒ| may suffice the condition of dominant magneto-optical coupling (i.e. for supporting at least one or more pairs of nearly degenerate defect states). On the other hand, |Vₑₒ|>10×|ωₑ-ωₒ| is preferred for good throughput in optical circulators. A device whose operation relies upon the presence of such rotating states will therefore be robust against small disorders.

### Optimization of the Domain Structure

Given the importance of obtaining large magneto-coupling strength|Vₑₒ|, we now proceed to maximize the spatial overlap between domain structure and the modal fields in Eq. (6). Due to the vectorial nature of defect states in photonic crystals, the cross product between the electric fields of the even mode |e

[symbol]

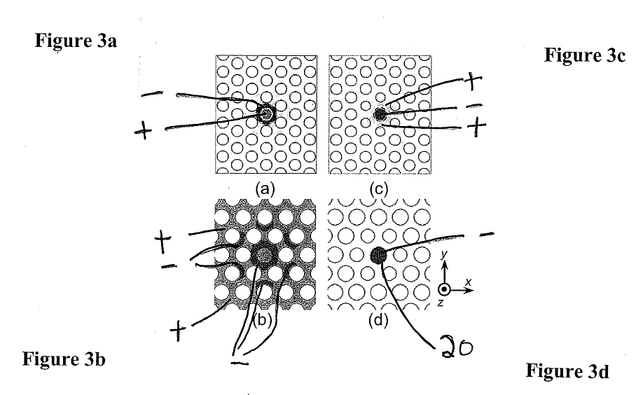

and the odd mode |o [symbol]
changes sign rapidly in the cavity, as shown in FIG. 3a. Thus, if the cavity consists of a single magnetic domain, the coupling strength diminishes. (|Vₑₒ| is numerically evaluated as 1.2×10⁻³|ε_{α}|ωₒₑ in this case.) On the other hand, the magneto-optical coupling can be maximized by inverting the domain structures according to the signs of the modal cross product. The appropriate domain structure that maximally couples the two modes |e [symbol]
and |o [symbol]
is shown in FIG. 3b, where the minimum feature size is about 150 nm for 1550 nm operational wavelength. (We note that domain structures with dimensions on the order of 18 nm have been fabricated experimentally. Z. Deng, E. Yenilmez, J. Leu, J. E. Hoffman, E. W. J. Straver, H. Dai, and K. A. Moler, “Metal-coated carbon nanotube tips for magnetic force microscopy,” Applied Physics Letters, vol. 85, pp. 6263-5, 2004). For a constant |ε_{α}| in the entire cavity region, the maximum |Vₑₒ| obtained with such domain structure is 0.0695|ε_{α}|ωₒₑ, nearly 50 times greater than the case of a uniform domain. In general, a large magneto-optical coupling critically depends on the correct domain pattern, while the relative magnitude of the diagonal and the off-diagonal element in the dielectric tensor can be a function of the space. In other words, cavities containing multiple gyrotropic materials can be designed to maximize the magneto-optical coupling through the same procedure detailed above.

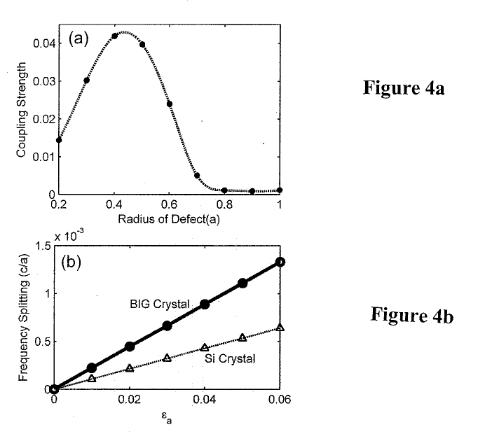

Alternatively, since the cross product of the modal field is well localized in the defect due to the strong field confinement from the photonic band gap, we can employ a simpler domain configuration, while still maintaining a moderately strong magneto-coupling. As an example, consider a silicon/air cavity similar to FIG. 3d with a single BIG domain 20 covering the center part of the cavity. Because of the index difference between silicon and BIG, the radius of the nodal circle of the modal cross product depends on the size of the BIG rod. Such dependence affects the overlap and results in an optimal radius r=0.4a where |Vₑₒ| is maximized, as shown in FIG. 4a. At this radius, the magneto-optical material completely filled the center region with a constant sign on the modal cross product shown in FIG. 3c. For the optimized structure shown in FIG. 3d, we show the magneto optical coupling constant as a function of the off-diagonal part in the dielectric tensor, calculated by finite-difference time-domain (FDTD) method (FIG. 4b). When compared with the pure BIG crystal with inverted domains, the Si/BIG hybrid cavity produces a slightly smaller coupling strength. Additional magnetic materials can also be incorporated into the cavity in the regions of the cavity where the sign of modal cross product is identical to the center region. Nevertheless, the simplified domain structure should facilitate experimental setup to achieve filly saturated magnetization under external magnetic biasing.

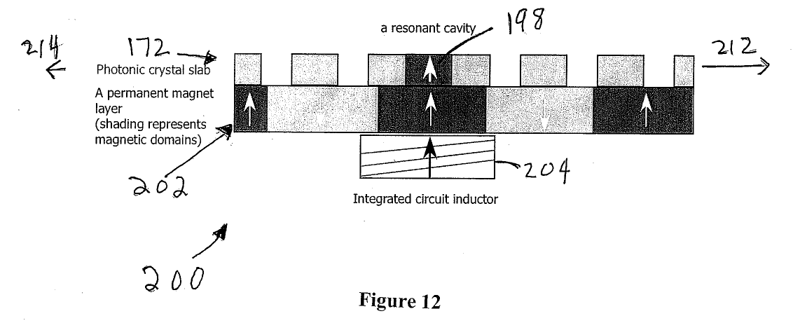

In reference to FIGS. 2a, 2b and 3d, the two degenerate dipole modes shown in FIGS. 2a and 2b are coupled by the BIG rod 20 by means of magneto-optical coupling, so that the photonic crystal slab in FIG. 3d no longer has time reversal symmetry. A single domain comprising the BIG rod 20 dominates induced magneto-optical coupling between the two degenerate dipole modes. Furthermore, the resonator in FIG. 3d has a plane defined by directions where the photonic crystal slab in FIG. 3d is periodic, which in this case is the plane of the paper. The E fields of the cavity mode are dominant in (and substantially confined to) this plane for the resonator of FIG. 3d, and the magnetization of the domain 20 is along a normal or near normal direction relative to this plane for a practical implementation of the resonator. This is illustrated also in reference to FIG. 12.

In fabricated devices, one or more additional magnetic domain can exist, in which the magnetization direction can be oriented along direction different from the applied magnetic bias. These domains can be tolerated when the dominant domain achieves the optimal pattern described in the previous paragraph. These unwanted domains can be ultimately eliminated by the application of a strong external magnetic bias with the field strength greater than the saturation magnetic field.

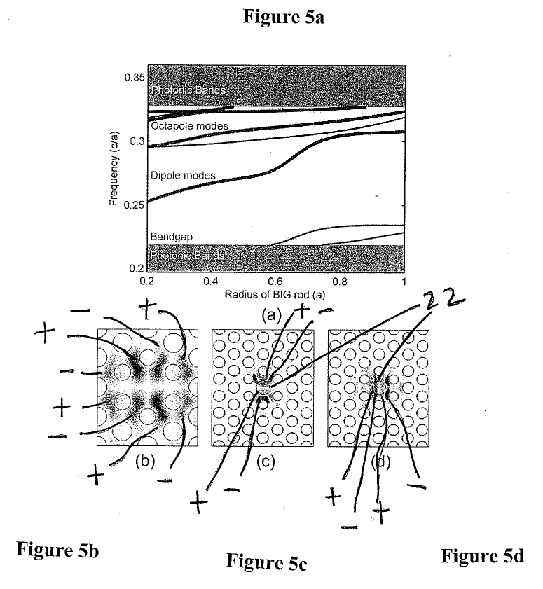

In the Si/BIG hybrid cavity structure, in addition to the dipole modes, there exist other modes inside the photonic band gap (FIG. 5a), including, for example, the octapole mode as shown in FIG. 5b. In principle, the presence of magneto-optical materials can create coupling between the dipole modes and these modes with other symmetries. The required substantially cylindrical domain structure 22 (shown in dotted lines) for such a coupling can be inferred from the modal cross-product as shown in FIGS. 5c and d. These modal cross-products feature a nodal plane at the center and has an odd mirror symmetry. Thus, with our choice of domain structures that has the full even symmetry of the structure, the magneto-optical couplings between modes from different irreducible representations are forbidden. In addition, as can be seen from Eq. (7), the effects of coupling between any two modes are weak if the frequency difference between the modes is large enough. Therefore, in the following analysis, we will be focusing primarily on the dipole modes while ignoring all the other modes in the system.

### Temporal Coupled-Mode Theory of Three-Port Optical Circulators

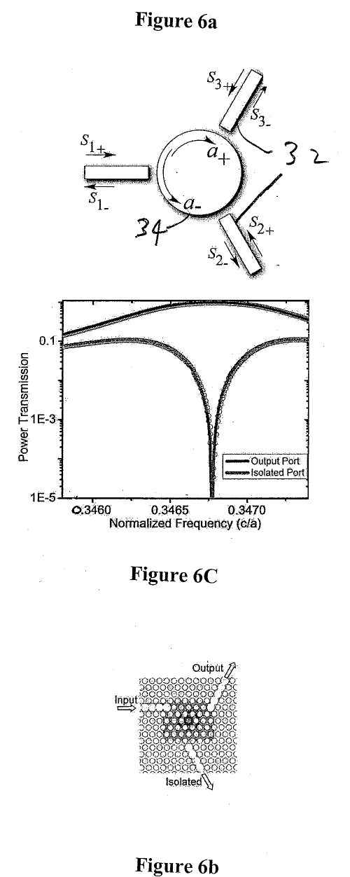

As an application of the nonreciprocal states in the magneto-optical resonators, we now construct a three-port optical circulator by using these rotating modes to create direction-dependent constructive or destructive interference. The structure is schematically shown in FIG. 6a, with three branches of waveguides (ports) 32 evanescently coupled to a resonant cavity 34 at the center. This optical resonator can be, but is not limited to, a photonic crystal cavity, a micro-ring, a micro-sphere or micro-disk resonator. It supports at least two counter-rotating modes |+

[symbol]

and |− [symbol]
as described in section 1, which have separated resonance frequencies ω₊ and ω₋ respectively under the strong magneto-optical coupling. For simplicity, we assume the entire structure have 120-degree rotational symmetry. Ideally, at the signal frequency the device shall allow complete transmission from ports 1 to 2, 2 to 3, and 3 to 1, while prohibiting transmission in the reversed directions. This transport characteristic can be accomplished with an appropriate choice of frequency splitting with respect to the decay rate of the resonance.

The system as shown in FIG. 6a can be described by the following temporal coupled mode theory equations: H. A. Haus, “Waves and fields in optoelectronics,” Englewood Cliffs, N.J.: Prentice-Hall, 1984; S. Fan, W. Suh, and J. D. Joannopoulos, “Temporal coupled-mode theory for the Fano resonance in optical resonators,” Journal of the Optical Society of America A: Optics and Image Science, and Vision, vo. 20, pp. 569-572, 2003; W. Suh, Z. Wang, and S. Fan, “Temporal coupled-mode theory and the presence of non-orthogonal modes in lossless multimode cavities,” IEEE Journal of Quantum Electronics, vol. 40, pp. 1511-1518, 2004.

$$\begin{matrix}\frac{d}{d t} ( \begin{matrix}{a}_{+} \\ {a}_{-}\end{matrix} ) = ( \begin{matrix}{iω}_{+} - {γ}_{+} & 0 \\ 0 & {iω}_{-} - {γ}_{-}\end{matrix} ) ( \begin{matrix}{a}_{+} \\ {a}_{-}\end{matrix} ) + {K}^{T} ( \begin{matrix}{S}_{1 +} \\ {S}_{2 +} \\ {S}_{3 +}\end{matrix} ) , & ( 8 ) \\ ( \begin{matrix}{S}_{1 -} \\ {S}_{2 -} \\ {S}_{3 -}\end{matrix} ) = ( \begin{matrix}- 1 & 0 & 0 \\ 0 & - 1 & 0 \\ 0 & 0 & - 1\end{matrix} ) ( \begin{matrix}{S}_{1 +} \\ {S}_{2 +} \\ {S}_{3 +}\end{matrix} ) + D ( \begin{matrix}{a}_{+} \\ {a}_{-}\end{matrix} ) . & ( 9 )\end{matrix}$$

α₊₍₋₎ is the normalized field amplitude of the counter-clockwise (clockwise) rotating mode. These modes resonate at frequencies ω₊₍₋₎ and decay at rates γ₊₍₋₎. Sᵢ₊₍₋₎ is the normalized amplitude of the incoming (outgoing) wave at port i. The 3×2 matrices, K and D, represents the coupling between the resonances and the waves at the ports. Unique in magneto-optical system under DC magnetic bias, the full time-reversal operation should include the reversal of external DC magnetic field. J. D. Jackson, Classical electrodynamics, 3rd ed. New York: Wiley, 1999. Thus, a full time-reversal operation flips the rotation directions of the cavity modes, and hence transform K to K*. Taking into account energy conservation and time-reversal properties of the structure, we can arrive at the following relations:

$$\begin{matrix}{D}^{+} D = 2 ( \begin{matrix}{γ}_{+} & 0 \\ 0 & {γ}_{-}\end{matrix} ) , & ( 10 ) \\ {K}^{*} = D , & ( 11 ) \\ ( \begin{matrix}- 1 & 0 & 0 \\ 0 & - 1 & 0 \\ 0 & 0 & - 1\end{matrix} ) {D}^{*} = - D & ( 12 )\end{matrix}$$

These conditions, in combination of the 120-degree rotational symmetry of the structure, leads to:

$${K}^{*} = D = ( \begin{matrix}\sqrt{2 {γ}_{+} / 3} & \sqrt{2 {γ}_{-} / 3} \\ {e}^{- i2π / 3} \sqrt{2 {γ}_{+} / 3} & {e}^{i2π / 3} \sqrt{2 {γ}_{-} / 3} \\ {e}^{- i4π / 3} \sqrt{2 {γ}_{+} / 3} & {e}^{i4π / 3} \sqrt{2 {γ}_{-} / 3}\end{matrix} ) . \qquad ( 13 )$$

In this derivation, we also assume that the main non-reciprocal effect of the magneto-optical materials is to introduce the frequency split between the counter rotating modes, while the coupling between these modes with the waveguides contain no non-reciprocal phase shift.

When wave at frequency ω is incident from port 1, the power transmission coefficients at ports 2 and 3 are solved from Eqs. (8)-(13) as:

$${T}_{1 -> 2} = {\vert \frac{2}{3} ( \frac{exp ( i4π / 3 )}{1 + i ( ω - {ω}_{+} ) / {γ}_{+}} + \frac{exp ( i2π / 3 )}{1 + i ( ω - {ω}_{-} ) {γ}_{-}} ) \vert}^{2} \\ {T}_{1 -> 3} = {\vert \frac{2}{3} ( \frac{exp ( i2π / 3 )}{1 + i ( ω - {ω}_{+} ) / {γ}_{+}} + \frac{exp ( i4π / 3 )}{1 + i ( ω - {ω}_{-} ) {γ}_{-}} ) \vert}^{2} , \qquad ( 14 )$$

The ideal circulator response with T_{1→3}=1 and T_{1→2}=0 can be obtained at an operational frequency ω₀, when the resonant frequencies are chosen to satisfy the following conditions: A similar condition has been derived for a microwave ferrite circulator in D. M. Pozar, Microwave Engineering, (John Wiley, New York, 1998). Our derivation is more general since we do not assume the detailed modal field pattern in the resonator region.

ω₊=ω₀+γ₃₀/\sqrt{3} and ω₋=ω₀-γ₋/\sqrt{3} (15)

In such a case, ports 2 and 3 function as the isolated and the output ports, respectively. (The roles of ports 2 and 3 are switched with ω₊<ω₋.) From Eq. (14) and (15), the transfer function from the input port to the output port takes a symmetric form with respect to ω₀ when γ₊≈γ₋. In this case, the structure possesses maximum bandwidth for given magneto-optical splitting |ω₊-ω₋|. The bandwidth for 30-dB isolation can be determined to be 0.0548|ω₊-ω₋|/π in the vicinity of ω₀ using Eq. (14). Also, by rotational symmetry of the structure, we have T_{1→2}=T_{2→3}=T_{3→1}=0, and T_{2→1}=T_{3→2}=T_{1→3}=1. Thus, transmission at frequency ω₀ is allowed only along the clockwise direction. Such a structure therefore behaves as an ideal circulator.

### Numerical Demonstration

To validate the theoretical analysis, we compare the analytical coupled-mode theory conclusion with first-principles FDTD calculations with a gyrotropic material model. A. P. Zhao, J. Juntunen, and A. V. Raisanen, “An efficient FDTD algorithm for the analysis of microstrip patch antennas printed on a general anisotropic dielectric substrate,” IEEE Transactions On Microwave Theory and Techniques, vol. 47, pp. 1142-1146, 1999. Using the BIG resonator we discussed in Section 4, a three-port Y-junction circulator is created by coupling three waveguides to the cavity shown in FIG. 6b. Each waveguide is constructed by enlarging the radius of a row of air holes to 0.55a. Such waveguides are single-moded at the mid-gap frequencies. These waveguides are spatially arranged to preserve the three fold rotational symmetry. This configuration also provides excellent control over the coupling between the cavity mode and the waveguides, as the quality factor increases monotonically with distance between the waveguide and the cavity. M. Notomi, A. Shinya, E. Kuramochi, S. Mitsugi, and H. Y. Ryu, “Slow-Light Waveguides and High-Q Nano-Resonators in Photonic Crystal Slabs,” presented at OSA Annual Meeting, Rochester, N.Y., 2004. To reduce computational costs we only include the magneto-optical domain in the vicinity of the cavity region. Filling the remaining computational cell with a single-magnetic domain shows no noticeable differences in the transport properties, since the fields are strongly localized in the cavity region and the waveguides are reciprocal due to the symmetric domain structure. A. G. Gurevich and G. A. Melkov, Magnetization Oscillations and Waves, Boca Raton: CRC Press, 1996. Thin bands of nonmagnetic region have been placed at the air-dielectric interface around the air holes to prevent numerical instability in FDTD simulations. The presence of these bands slightly reduced the maximum magneto-splitting achievable in time-domain calculation for given value of εa. (Since the use of a rectangular grid for triangular lattices itself breaks 3-fold rotational symmetry, we have also compensated the numerical dispersion by small modification in the cavity region.)

In the transmission calculation with FDTD method, we choose εa-0.02463. With the choice, the two rotating modes have frequencies 0.3465 (c/a) and 0.3471 (c/a), and quality factors 364 and 367, satisfying the conditions in Eq. (14). The FDTD calculations indeed demonstrate nearly ideal three-port circulator characteristics and agree nicely with the coupled-mode theory (FIG. 6c). The numerical simulations thus confirm the validity of temporal coupled mode theory approach in Eqs. (8)-(13). The maximum extinction ratio, defined as the power transmission ratio between the output port and the isolated port, reaches 45 dB. The extinction is limited by direct tunneling between the waveguides. The bandwidth for 30 dB isolation exceeds 6×10−5 (c/a).

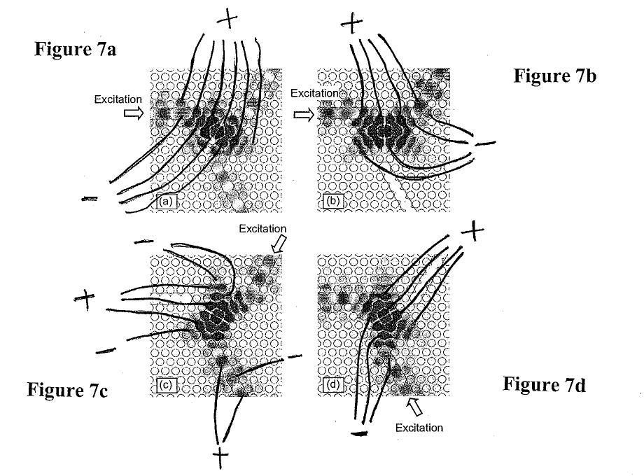

The steady-state field patterns at a frequency 0.3468 (c/a), where maximum isolation occurs, are shown in FIG. 7. In the absence of magneto-optical material in the cavity, light is transmitted to both output ports (FIG. 7a). In contrast, the magneto-optical resonator shows nearly 100% transmission to the output port and zero transmission to the isolated port (FIG. 4b). Moreover, light incident into the output port is completely dropped to the isolated port (FIG. 7c) and light incident into the isolated port is transferred to the input port (FIG. 7d). Evidently, an ideal isolator characteristics is observed at the operational frequency and the input port is therefore free from the back reflections from the output port.

The proposed device occupies only a small footprint of a few wavelength square. While the simulation in this paper is two-dimensional, the coupled-mode theory analysis, and hence the principles of the device, applies to three-dimensional cavity systems. For implementations in BIG thin films, the material exhibits strong gyrotropy with εa saturated at 0.06. T. Tepper and C. A. Ross, “Pulsed laser deposition and refractive index measurement of fully substituted bismuth iron garnet films,” Journal of Crystal Growth, vol. 255, pp. 324-31, 2003; N. Adachi, V. P. Denysenkov, S. I. Khartsev, A. M. Grishin, and T. Okuda, “Epitaxial Bi₃Fe₅O₁₂(001) films grown by pulsed laser deposition and reactive ion beam sputtering techniques,” Journal of Applied Physics, vol. 88, pp. 2734-2739, 2000. From the coupled-mode theory, the bandwidth of the circulator scales linearly with the magneto-optical coupling strength. Hence the BIG device can provide a large bandwidth for 30 dB isolation up to 213 GHz, when operating at 633 nm. Since the quality factor of the resonator due to waveguide coupling can be as low as 140, the relative large material absorption in BIG can be still tolerated. At optical communication wavelength of 1550 nm, Ce:Yttrium Iron Garnet (Ce:YIG) has εa saturated at 0.009 with very low absorption. M. Huang and S. Y. Zhang, “Growth and characterization of cerium-substituted yttrium iron garnet single crystals for magneto-optical applications,” Applied Physics A (Materials Science Processing), vol. A74, pp. 177-180, 2002. For this material system, the bandwidth for 30 dB isolation at 1550 nm is estimated as 12.6 GHz.

### Coupled-Mode Theory of a Channel Add/Drop Filter

Using the same rotating states that enable the construction of a three-port optical circulator, we can design another important optical device that shows nonreciprocal transmission characteristics as well as significant suppression of disorders. This type of device is based on a four-port channel add/drop filter.

Optical channel add/drop filters (ADFs) have been intensely researched since they are essential for wavelength-division multiplexed (WDM) systems. ADFs allow an optical signal at a specific wavelength to be injected into or/and extracted from a bus waveguide while leaving channels at other wavelengths intact. S. Fan, P. R. Villeneuve, J. D. Joannopoulos, and H. A. Haus, “Channel drop tunneling through localized states,” Physical Review Letters, vol. 80, pp. 960-963, 1998; S. Fan, P. R. Villeneuve, and J. D. Joannopoulos, “Channel drop filters in photonic crystals,” Optics Express, vol. 3, pp. 4-11, 1998. Using resonance tunneling through photonic crystals defects, photonic crystal optical ADFs with a device dimension approaching micron scales have been successfully proposed or demonstrated by many research teams. S. Noda, T. Baba, and Optoelectronic Industry and Technology Development Association (Japan), Roadmap on photonic crystals. Dordrecht; Boston: Kluwer Academic Publishers, 2003; H. Takano, B. S. Song, T. Asano, and S. Noda, “Highly efficient in-plane channel drop filter in a two-dimensional heterophotonic crystal,” Appl. Phys. Lett. (USA), vol. 86, pp. 241101-241102, 2005.

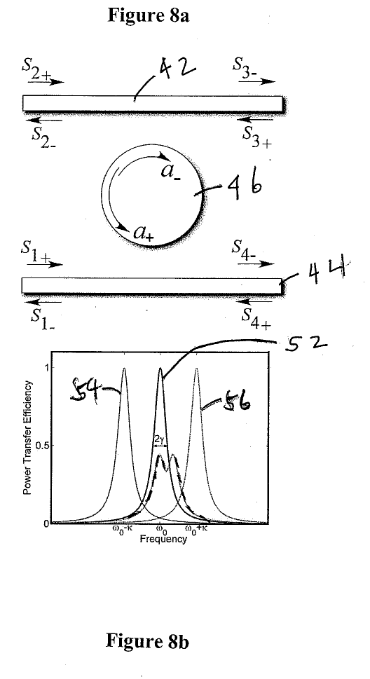

We start by briefly reviewing the operating principle of the original channel ADF structure in photonic crystals, highlighting only those features that are relevant for the discussions of magneto-optical effects. Sketched in FIG. 8a, a four-port ADF consists of a bus waveguide 42 and a drop waveguide 44, both evanescently coupled to a resonator system 46. The evanescent coupling through the resonator system leads to an energy transfer between the two waveguides (ports) on resonance. The ideal operation of this device relies upon the use of two resonances with opposite symmetries and the degeneracy between the two resonances in terms of both frequencies and quality factors. Under these conditions, constructive interference at the output port and destructive interference at all other ports are accomplished simultaneously. The absence of reflection in this structure eliminates the need of channel sorting or the use of optical circulators, B. S. Song, T. Asano, Y. Akahane, Y. Tanaka, and S. Noda, “Multichannel add/drop filter based on in-plane hetero photonic crystals,” J Lightwave Technol, vol. 23, pp. 1449-1455, 2005; M. Notomi, A. Shinya, S. Mitsugi, E. Kuramochi, and H. Y. Ryu, “Waveguides, resonators and their coupled elements in photonic crystal slabs,” Optics Express, vol. 12, pp. 1551-1561, 2004, thereby allowing simpler system designs.

The structure can be analyzed with a coupled-mode approach. W. Suh, Z. Wang, and S. Fan, “Temporal coupled-mode theory and the presence of non-orthogonal modes in lossless multimode cavities,” IEEE Journal of Quantum Electronics, vol. 40, pp. 1511-1518, 2004; H. A. Haus and W. P. Huang, “Coupled-mode theory,” Proceedings of IEEE, vol. 79, pp. 1505-1518, 1991; C. Manolatou, M. J. Khan, S. H. Fan, P. R. Villeneuve, H. A. Haus, and J. D. Joannopoulos, “Coupling of modes analysis of resonant channel add-drop filters,” IEEE Journal of Quantum Electronics, vol. 35, pp. 1322-31, 1999. With a mirror symmetry, a properly designed defect supports an even modes |e

[symbol]

and an odd mode |o [symbol]
oscillating at complex frequencies of ω_{e,o}+i2γ_{e,o} respectively. The time evolution of the cavity mode amplitudes α_{e,o} in the presence of the incoming (outgoing) waves at the port i with amplitude Sᵢ₊₍₋₎ are described by the following equations:

$$\begin{matrix}\frac{d}{d t} ( \begin{matrix}{a}_{e} \\ {a}_{o}\end{matrix} ) = ( \begin{matrix}{iω}_{e} - 2 {γ}_{e} & 0 \\ 0 & {iω}_{o} - 2 {γ}_{o}\end{matrix} ) ( \begin{matrix}{a}_{e} \\ {a}_{o}\end{matrix} ) + {K}_{eo}^{T} ( \begin{matrix}{S}_{1 +} \\ {S}_{2 +} \\ {S}_{3 +} \\ {S}_{4 +}\end{matrix} ) , & ( 1 ) \\ ( \begin{matrix}{S}_{1 -} \\ {S}_{2 -} \\ {S}_{3 -} \\ {S}_{4 -}\end{matrix} ) = ( \begin{matrix}0 & 0 & 0 & 1 \\ 0 & 0 & 1 & 0 \\ 0 & 1 & 0 & 0 \\ 1 & 0 & 0 & 0\end{matrix} ) ( \begin{matrix}{S}_{1 +} \\ {S}_{2 +} \\ {S}_{3 +} \\ {S}_{4 +}\end{matrix} ) + {D}_{eo} ( \begin{matrix}{a}_{e} \\ {a}_{o}\end{matrix} ) . & ( 2 )\end{matrix}$$

By observing the constraints from energy conservation and time-reversal symmetry, one can show that: W. Suh, Z. Wang, and S. Fan, “Temporal coupled-mode theory and the presence of non-orthogonal modes in lossless multimode cavities,” IEEE Journal of Quantum Electronics, vol. 40, pp. 1511-1518, 2004.

$${K}_{eo} = {D}_{eo} = ( \begin{matrix}i \sqrt{{γ}_{e}} & \sqrt{{γ}_{o}} \\ - i \sqrt{{γ}_{e}} & \sqrt{{γ}_{o}} \\ - i \sqrt{{γ}_{e}} & - \sqrt{{γ}_{o}} \\ i \sqrt{{γ}_{e}} & - \sqrt{{γ}_{o}}\end{matrix} ) . \qquad ( 3 )$$

When an accidental degeneracy of the complex frequencies is maintained, i.e. ωₑ=ωₒ and γₑ=γₒ, an input wave from port 1 excites a circularly hybridized state|+ [symbol]
=(|e [symbol] +i|o [symbol]
)/\sqrt{2}. Such a state then decays only into port 2 and port 4. S. Fan, P. R. Villeneuve, and J. D. Joannopoulos, “Channel drop filters in photonic crystals,” Optics Express, vol. 3, pp. 4-11, 1998. The destructive interference between the decayed wave from the cavity and direct transmission from port 1 to 4 leads to zero transmission at port 4, while the decayed wave at port 2 creates a complete transfer on resonance. The time-reversed transfer from port 2 to port 1 occurs at an identical frequency through the other resonant mode |− [symbol]
=(|e [symbol] −i|o [symbol]
)/\sqrt{2}.

Mathematically, when the degeneracy condition is satisfied, the operation of the device can be more easily described with Eqs. (4)-(6), which can be shown to be equivalent to Eqs. (1)-(3) via a unitary transformation:

$$\begin{matrix}\frac{d}{d t} ( \begin{matrix}{a}_{+} \\ {a}_{-}\end{matrix} ) = ( \begin{matrix}{iω}_{+} - 2 {γ}_{o} & 0 \\ 0 & {iω}_{-} - 2 {γ}_{o}\end{matrix} ) ( \begin{matrix}{a}_{+} \\ {a}_{-}\end{matrix} ) + {K}_{\pm }^{T} ( \begin{matrix}{S}_{1 +} \\ {S}_{2 +} \\ {S}_{3 +} \\ {S}_{4 +}\end{matrix} ) , & ( 4 ) \\ \begin{matrix}( \begin{matrix}{S}_{1 -} \\ {S}_{2 -} \\ {S}_{3 -} \\ {S}_{4 -}\end{matrix} ) = ( \begin{matrix}0 & 0 & 0 & 1 \\ 0 & 0 & 1 & 0 \\ 0 & 1 & 0 & 0 \\ 1 & 0 & 0 & 0\end{matrix} ) ( \begin{matrix}{S}_{1 +} \\ {S}_{2 +} \\ {S}_{3 +} \\ {S}_{4 +}\end{matrix} ) + {D}_{\pm } ( \begin{matrix}{a}_{+} \\ {a}_{-}\end{matrix} ) , \\ {K}_{\pm } = \sqrt{2 {γ}_{o}} ( \begin{matrix}i & 0 \\ 0 & 1 \\ - i & 0 \\ 0 & - 1\end{matrix} ) , {D}_{\pm } = \sqrt{2 {γ}_{o}} ( \begin{matrix}0 & 1 \\ - i & 0 \\ 0 & - 1 \\ i & 0\end{matrix} ) ,\end{matrix} & ( 5 ) \\ {ω}_{+} = {ω}_{-} . & ( 6 )\end{matrix}$$

Using Eqs. (4) -(6), the spectrum for transmission, transfer and reflection can be determined as

$$\begin{matrix}{T}_{1 -> 2} = {T}_{2 -> 1} = {T}_{3 -> 4} = {T}_{4 -> 3} = {\vert \frac{2 γ}{j ( ω - {ω}_{0} ) + 2 γ} \vert}^{2} , \\ {T}_{1 -> 4} = {T}_{4 -> 1} = {T}_{2 -> 3} = {T}_{3 -> 2} = {\vert 1 - \frac{2 γ}{j ( ω - {ω}_{0} ) + 2 γ} \vert}^{2} , \\ {R}_{1} = {R}_{2} = {R}_{3} = {R}_{4} = {T}_{1 -> 3} = {T}_{3 -> 1} = {T}_{2 -> 4} = {T}_{4 -> 2} = 0.\end{matrix} \qquad ( 7 )$$

Thus, complete transfer between the bus and drop waveguides and zero reflection can be achieved on resonance ωₒ with a bandwidth of 2γ. (ideal curve 52 in FIG. 8b)

In fabricated devices, the dielectric function εᵣ(r) would unavoidably deviate from the designed dielectric function ε_{d}(r). The effects of small perturbations, i.e. Δεᵣ=εᵣ-ε_{d}, can be determined by introducing an off-diagonal element into the frequency matrices in Eqs. (1) and (4). The disorders in the vicinity of the cavity affect mainly the real part of the frequencies. Their effects can be expressed as a coupling strength between the even and odd modes: Y. Xu, Y. Li, R. K. Lee, and A. Yariv, “Scattering-theory analysis of waveguide-resonator coupling,” Physical Review E (Statistical Physics, Plasmas, Fluids, and Related Interdisciplinary Topics), vol. 62, pp. 7389-404, 2000.

$${V}_{e , o} = \frac{{ω}_{o}}{2} \int {ɛ}_{d}^{2} [ \frac{1}{{ɛ}_{r}} - \frac{1}{{ɛ}_{d}} ] {\vec{E}}_{e}^{*} \cdot {\vec{E}}_{o} d V \qquad ( 8 )$$

Such perturbation lifts the degeneracy and creates eigenstates that are drastically different from the preferred states |e [symbol] ±i|o

[symbol]

resulting in significant reflection and reduction in transfer efficiency. As an example, we show in FIG. 8b the spectrum of transfer efficiency, assuming that the two resonances 54 and 56 have the same decay rate, but are separated in real part of the frequency by 1.7γ. In general, the spectrum deviates significantly from ideal characteristics when the frequency splitting is comparable to the width of the resonance. Since the linewidth in these structures is typically very narrow, as dictated by the applications, the resulting requirements for fabrication accuracy can be very stringent.
6. Channel Add/Drop Filters with Magneto-Optical Materials in the Cavity

Here we seek to fundamentally suppress the effects from resonant-frequency splitting originated from fabrication inaccuracy by breaking time-reversal symmetry. It was recently shown that when magneto-optical material is introduced into the cavity region, the resulting eigenstates can assume a circularly “hybridized” waveform |e [symbol] ±i|0

[symbol]

Z. Wang and S. F. Fan, “Optical circulators in two-dimensional magneto-optical photonic crystals,” Optics Letters, vol. 30, pp. 1989-1991, 2005. In this case, the time-reversal symmetry is broken, and the time-reversed pair |e [symbol]
±i|o [symbol]
oscillates at different frequencies. When the frequency separation induced by magneto-optics is much larger than the splitting caused by fabrication disorders, the eigenstates of the systems are largely immune from fabrication disorders. Below, we will show that magneto-optical effects can be very beneficial for channel ADF functions.

Analytically, the effect due to the presence of magneto-optical materials can be described with imaginary and anti-symmetric off-diagonal elements in the frequency matrix. Z. Wang and S. Fan, “Magneto-optical defects in two-dimensional photonic crystals,” Applied Physics B: Lasers and Optics, vol. 81, pp. 369-375, 2005. In the case of two modes, if we start with a structure that satisfies the degeneracy condition, after the introduction of magneto-optical effects, Eq. (1) is modified as:

$$\frac{d}{d t} ( \begin{matrix}{a}_{e} \\ {a}_{o}\end{matrix} ) = ( \begin{matrix}{iω}_{o} - 2 {γ}_{o} & iκ \\ - iκ & {iω}_{o} - 2 {γ}_{o}\end{matrix} ) ( \begin{matrix}{a}_{e} \\ {a}_{o}\end{matrix} ) + {K}_{eo}^{T} ( \begin{matrix}{S}_{1 +} \\ {S}_{2 +} \\ {S}_{3 +} \\ {S}_{4 +}\end{matrix} ) . \qquad ( 9 )$$

Diagonalizing the frequency matrix yields equations that are the same as Eqs. (4)-(5), except with ω₊=ω₀+κ and ω₋=ω₀-κ. The transmission, reflection, and transfer spectra can be calculated from Eqs. (5) and (9) as

$${T}_{1 -> 2} = {T}_{3 -> 4} = {\vert \frac{2 γ}{j ( ω - {ω}_{+} ) + 2 γ} \vert}^{2} , \\ {T}_{2 -> 1} = {T}_{4 -> 3} = {\vert \frac{2 γ}{j ( ω - {ω}_{-} ) + 2 γ} \vert}^{2} , \\ {T}_{1 -> 4} = {T}_{3 -> 2} = {\vert 1 - \frac{2 γ}{j ( ω - {ω}_{+} ) + 2 γ} \vert}^{2} , \\ {T}_{2 -> 3} = {T}_{4 -> 1} = {\vert 1 - \frac{2 γ}{j ( ω - {ω}_{-} ) + 2 γ} \vert}^{2} . \qquad ( 10 )$$

Thus, ideal channel add/drop characteristics are maintained, while the transport properties become direction-dependent and nonreciprocal.

The presence of disorders introduces additional real off-diagonal elements (i.e. V_{e,o} as defined in Eq. (8)) into the frequency matrix. However, |e

[symbol]

±i|o [symbol]
remain the eigenstates for Eq. (9), as long as magneto-optical coupling dominates, i.e. |κ|>>|Vₑₒ|. Consequently, the ideal operation of the ADF is protected against disorders when significant magneto-optical coupling is present.

### Alternative Implementations

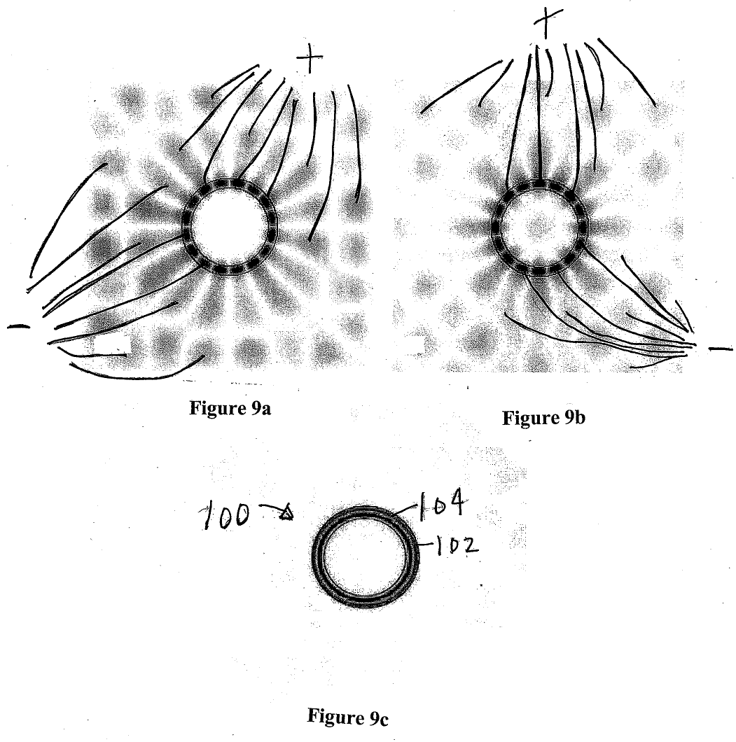

The nonreciprocal operation can be also applied to other integrated optical device, such as micro-ring (micro-disk), micro-toroid or micro-sphere resonators. As an example, the eigenmodes in a micro-ring resonator can also be categorized as even and odd modes (FIGS. 9a and 9b). FIGS. 9a and 9b are diagrams illustrating a pair of degenerate even and odd resonant modes respectively of a 2D ring resonator consisting of a ring of high-index material. The structure can be seen as the intensity of the magnetic field along out-of-plane directions represented as the “+” and “−” regions. FIG. 9c is a diagram of the corresponding magnetic domain structure necessary to couple the modes plotted in FIGS. 9a and 9b. As can be seen from FIG. 9c, the 2D ring resonator 100 comprises a domain of material 102 such as BIG, embedded in a material 104. Instead of being the plane where a photonic crystal is periodic for the case of photonic crystals as described above, the plane of the largest dimension of the micro-ring, micro-disk, micro-toroid or micro-sphere resonator defines the plane where the E fields substantially are confined to, and where a single domain can dominate induced magneto-optical coupling between two degenerate dipole modes. The related magnetic domain pattern is two simple concentric ring domains with opposite magnetization along the out-of-plane direction (FIG. 9c). The sidewall roughness in fabricated devices can be well tolerated in the limit of strong magneto-optical coupling, which otherwise has been a limiting factor in III-V semiconductor or iron garnet film based systems.

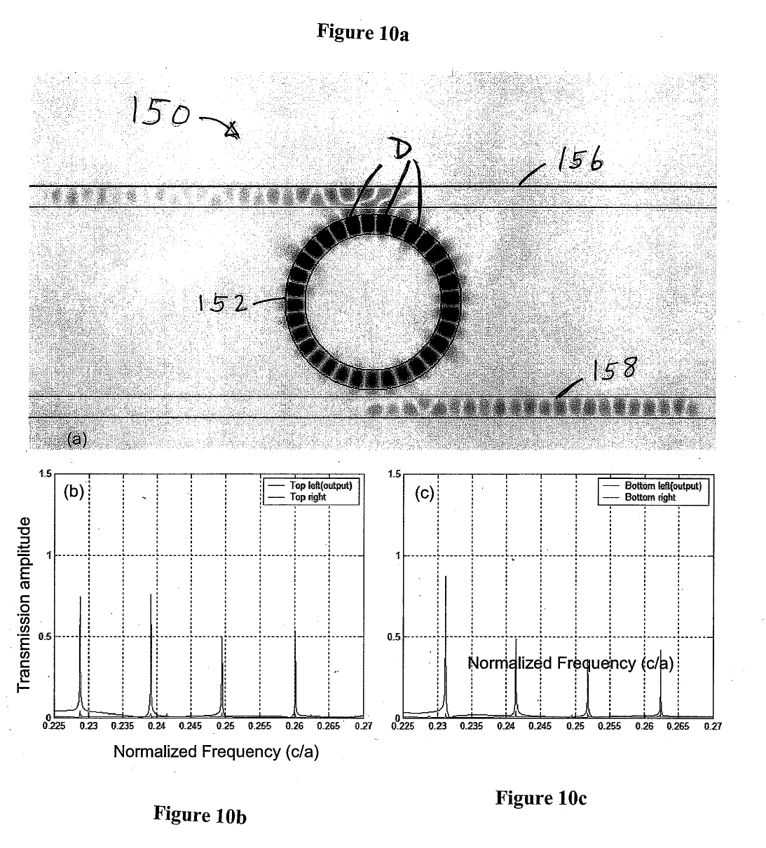

FIG. 10a is a top view of a micro-ring add/drop filter 150, where the high-index materials are outlined with black lines, in which a ring shaped structure 152 is identical to the structure in FIG. 9c. Filter 150 also includes a top waveguide 156 and a bottom waveguide 158. The fields snapshot (with darker shading labeled D representing high field intensity regions) in FIG. 10a is calculated with finite-different time domain method and represents the magnetic field of the structure excited from the top left port of the waveguide. FIG. 10b is a graphical plot of the field transmission spectra of the device 150 excited with the left port of the top waveguide 156. FIG. 10c is a graphical plot of the field transmission spectra of the device excited with the left port of the bottom waveguide 158.

The magneto-optical effect again renders the eigenstates to be two counter propagating modes at disparate frequencies, which can be probed when the resonator 152 is coupled to two parallel waveguides 156 and 158 shown in FIG. 10a. The excitation from the upper and the lower waveguide excites resonator modes propagating along the opposite directions respectively, and the sharp transmission peaks situate different frequencies in two cases (FIGS. 10b and 10c). With proper adjustment of the resonance decay rate, as described above, a nonreciprocal four-port circulator can be formed with micro-ring (micro-disk) structures.

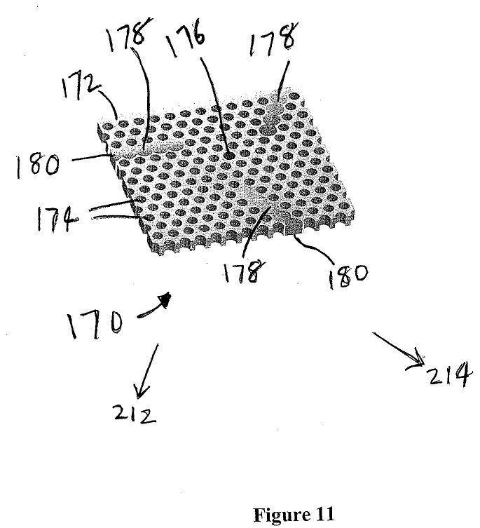

While the simulations here are for two-dimensional structures, the operating principles, as described by coupled-mode theories, can be readily applied to three-dimensional structures including of photonic crystal slabs (FIG. 11) and three-dimensional crystals. FIG. 11 is a schematic view of 2D photonic crystal slabs implementation of a 3-port circulator structure 170 formed by a silicon slab 172 with lithographically defined airholes 174. One of the holes is infiltrated with Ce:YIG 176 and the waveguides 178 are enlarged airholes. Waveguides 178 couple 3 optical ports 180 to the resonator at 176. The plane of circulator structure 170 is defined by the plane in which the airholes 174 are periodic. Povinelli, S. G. Johnson, S. Fan, and J. D. Joannopoulos, “Emulation of two-dimensional photonic crystal defect modes in a photonic crystal with a three-dimensional photonic band gap,” Physical Review B (Condensed Matter and Materials Physics), vol. 64, pp. 075313-8, 2001. The proposed devices are capable of significantly reducing the insertion loss and inter-stage reflection, while their dimensions are only limited by the constraints on the out-of-plane radiation loss.

Additionally, the role of the output port and the isolated port for the three-port and the four-port circulators are determined by the magnetization direction of the magneto-optical material. When combined with integrated inductor co-fabricated with the optical device, the circulator structures can be used as electrically reprogrammable optical switches. By changing the direction of the current flow in the inductor 204, the bias magneto-optical material can be inverted, so that the output port and the isolated port are interchanged. This can be achieved with or without the permanent magnet 202, as shown in FIG. 12, depending on the coercity of the gyrotropic material 198 in the optical resonator 172. FIG. 12 is a schematic view of electrically tunable circulator 200 (a reconfigurable optical switch) from the side view, formed by a photonic crystal slab 172 on top of a permanent magnet 202 and an inductor 204. The arrows represent the direction of the magnetization or the magnetic fields. Note the permanent magnet also consists of several magnetic domains (naturally occurring in garnet films to lower the magneto-static energy). The integrated circuit inductor can be fabricated with standard CMOS process and wafer-bond to the optical chip. The plane of the photonic crystal slab 172 is defined by the plane in which the slab is periodic. This is illustrated by the arrows 212 and 214 in FIGS. 11 and 12.

For magneto-optical materials 198 with large coercity, namely a permanent magnet, the resonant cavity can serve dual purposes as both the optical resonator and the permanent magnet. In such cases, external magnetic bias may not be necessary and the switching characteristic of the device are stable against small changes of the external field. Such devices can serve as optical read-only memory cell, as the binary information is stored as the switching direction of the input signal.

The gyrotropic material used for achieving the magneto-optical coupling between nearly degenerate defect states may comprise bismuth iron garnet, or other iron garnet, or diluted magnetic semiconductors.

Embodiments of the resonator system of this invention may comprise a two-dimensional photonic crystal resonator, a photonic crystal slab, or a micro-ring (or micro-disk/micro-toroid/micro-sphere) resonator.

While the invention has been described above by reference to various embodiments, it will be understood that changes and modifications may be made without departing from the scope of the invention, which is to be defined only by the appended claims and their equivalent. All references referred to herein are incorporated by reference in their entireties.

What is claimed is:

1. A resonator system comprising:
an optical resonator that supports one or more pairs of nearly degenerate defect states; and
a single magnetic domain comprising at least one gyrotropic material in the optical resonator causing magneto-optical coupling between the two states so that the system lacks time-reversal symmetry, wherein said single magnetic domain dominates induced magneto-optical coupling between said defect states.

2. The system of claim 1, said resonator having a cavity mode and a plane in which an electric field of the cavity mode of the resonator is dominant, wherein magnetization of said magnetic domain is along a normal or near normal direction with respect to the plane.

3. The system of claim 1, wherein said gyrotropic material comprises bismuth iron garnet, iron garnet, or diluted magnetic semiconductors.

4. The system of claim 3, wherein the magneto-optical coupling is at least about 3 times a difference in frequency between the two states.

5. The system of claim 4, wherein the magneto-optical coupling is at least about 10 times a difference in frequency between the two states.

6. The system of claim 1, said resonator being a two-dimensional photonic crystal resonator, a cavity in photonic crystal slab, or a micro-ring, micro-disk, micro-toroid or micro-sphere resonator.

7. A circulator comprising:
an optical resonator that supports one or more pairs of nearly degenerate defect states;
at least one gyrotropic material in the optical resonator causing magneto-optical coupling between the two states so that the system lacks time-reversal symmetry;
three optical ports; and
a plurality of wave guides coupling the three optical ports to the optical resonator.

8. The circulator of claim 7, said resonator having a cavity mode and a plane in which an electric field of the cavity mode of the resonator is dominant, wherein magnetization of said magnetic domain is along a normal or near normal direction with respect to the plane.

9. The circulator of claim 8, wherein said at least one gyrotropic material contains only one magnetic domain.

10. The circulator of claim 7, wherein said gyrotropic material comprises bismuth iron garnet, iron garnet, or diluted magnetic semiconductors.

11. The circulator of claim 7, wherein the magneto-optical coupling is at least about 3 times a difference in frequency between the two states.

12. The circulator of claim 7, said resonator being a two-dimensional photonic crystal resonator, a cavity in photonic crystal slab, or a micro-ring, micro-disk, micro-toroid or micro-sphere resonator.

13. A switch comprising:
a circulator comprising:
(a) an optical resonator that supports one or more pairs of nearly degenerate defect states;
(b) at least one gyrotropic material in the optical resonator causing magneto-optical coupling between the two states so that the system lacks time-reversal symmetry; and
(c) a plurality of wave guides coupled to the optical resonator; and
an instrument applying a magnetic field to the at least one gyrotropic material to control the passage of light between the wave guides to achieve switching functions.

14. The switch of claim 13, said resonator having a cavity mode and a plane in which an electric field of the cavity mode of the resonator is dominant, wherein magnetization of said magnetic domain is along a normal or near normal direction with respect to the plane.

15. The switch of claim 13, wherein said at least one gyrotropic material contains only one magnetic domain.

16. A memory comprising:
a circulator comprising:
(a) an optical resonator that supports one or more pairs of nearly degenerate defect states;
(b) at least one gyrotropic material in the optical resonator causing magneto-optical coupling between the two states so that the system lacks time-reversal symmetry; and
(c) a plurality of wave guides coupled to the optical resonator; and
a magnet applying a magnetic field to the at least one gyrotropic material to control the optical path of light between the wave guides.

17. The memory of claim 16, said resonator having a cavity mode and a plane in which an electric field of the cavity mode of the resonator is dominant, wherein magnetization of said magnetic domain is along a normal or near normal direction with respect to the plane.

18. The memory of claim 16, wherein said at least one gyrotropic material contains only one magnetic domain.

19. A memory comprising:
a circulator comprising:
(a) an optical resonator that supports one or more pairs of nearly degenerate defect states;
(b) at least one gyrotropic material in the optical resonator causing magneto-optical coupling between the two states so that the system lacks time-reversal symmetry; and
(c) a plurality of wave guides coupled to the optical resonator;
wherein said at least one gyrotropic material operates as a permanent magnet.

20. An add drop filter comprising:
a micro-ring resonator that supports one or more pairs of nearly degenerate defect states; said resonator comprising at least one gyrotropic material causing magneto-optical coupling between the two states so that the system lacks time-reversal symmetry; and
a plurality of wave guides coupled to the optical resonator.
